(19) United States
(12) Patent Application Publication
(10) Pub. No.: US 2016/0355734 A1
(43) Pub. Date: Dec. 8, 2016

(54) CURABLE RESIN COMPOSITION FOR SEALING LIQUID CRYSTAL

(71) Applicant: Henkel AG & Co. KGaA, Duesseldorf (DE)

(72) Inventors: Jing Zhou, Shanghai (CN); Tengfang Wang, Shanghai (CN); Qin Li, Shanghai (CN); Dawei Chen, Shanghai (CN)

(21) Appl. No.: 15/241,767

(22) Filed: Aug. 19, 2016

Related U.S. Application Data
(63) Continuation-in-part of application No. PCT/CN2014/072251, filed on Feb. 19, 2014.

(51) Int. Cl. C09K 19/54; B32B 7/04; B32B 37/18; B32B 37/00; G02F 1/1339; B32B 7/14; B32B 17/06; B32B 37/12; G02F 1/1341; C09J 179/08; B32B 37/06

(52) U.S. Cl. CPC C09K 19/542; C09J 179/08; B32B 7/045; B32B 37/18; B32B 37/0076; B32B 37/06; B32B 7/14; B32B 17/06; B32B 37/0038; B32B 37/12; G02F 1/1341; G02F 1/1339; B32B 2457/202; B32B 2037/1253; B32B 2250/02; B32B 2315/08; B32B 2255/00; B32B 2310/0831; G02F 2001/13415

(57) ABSTRACT

The present invention relates to a curable resin composition for sealing liquid crystal. The curable resin composition comprises a maleimide resin, an epoxy resin, a thermal free radical initiator, and a latent epoxy curing agent. More specifically, the resin composition can be cured with a combination of ultraviolet (UV) radiation and heat, resulting in a cured product with good curability in light-shielded area, excellent adhesion strength and high reliability.

### TECHNICAL FIELD

This invention relates to a curable resin composition for sealing liquid crystal and use of a curable resin composition in a method for manufacturing a liquid crystal display.

### BACKGROUND OF THE INVENTION

Liquid crystal display (LCD) panels having the characteristics of being light-weight and high-definition have been widely used as display panels for a variety of apparatuses including cell phones and TVs. Conventionally, the process for producing a LCD panel is called a “vacuum-injection” process, which comprises applying a heat-curable sealant composition on a glass substrate with electrode, joining opposite facing glass substrates to each other, heat pressing and curing the resultant to form a cell, injecting the liquid crystal into the cell under vacuum, and then sealing the inlet after injection.

The conventional process described above has issue of cell gap variation due to heat distortion upon heat-curing. Furthermore, with the increasing demand of LCD panels including small size for cell phones and large size for TVs in recent years, it has been noticed that the vacuum-injecting process is very time-consuming, which is a disadvantage for mass production.

To solve above mentioned problems, the one-drop-filling (ODF) process has been proposed. ODF comprises applying a sealant on a substrate having an electrode pattern and an alignment film under vacuum condition, dropping liquid crystal on the substrate having the sealant applied thereon, joining opposite facing substrates to each other under vacuum, then releasing the vacuum and performing ultraviolet (UV) irradiation or UV plus heat to cure the sealant and thereby producing a LCD cell.

The sealants used in ODF process are normally UV curable or alternatively UV and heat curable. The UV curable sealants use an UV-curable acryl-based resin as the main ingredient, while an UV and heat curable sealants use partially acrylated epoxy resin as the main ingredient. While using the UV plus heat curable sealant, the UV-irradiation is performed in the first step to allow rapid fixing of the substrates, followed by heat-curing in order to complete the curing of the sealant. This type of sealant is considered to provide higher reliability than UV curable sealant, and therefore, this method has been the main manufacturing method for LCD panels during recent years.

Usually the glass substrate has an electrode pattern, which is a complex metal wiring and which overlaps with the sealant pattern, and therefore, results in some light-shielded area or shadow area. If the sealant located in the light-shielded area cannot be fully cured, subsequently in the post heat cure process the liquid crystal will easily penetrate into the sealant, or the uncured resin composition will contaminate the liquid crystal under heat condition. Both above mentioned scenarios cause large decrease of display quality of the LCD panel. With the increasing demand of high resolution of display, the metal wiring is more and more complex, and therefore, the light-shielded area is also becoming greater, this creates a strong requirement for the good cure performance under the light-shielded area.

In addition, development of LCD is more towards the direction of “slim border” or “narrow bezel” design. Among several ways to achieve this goal, one is the use of a narrow width of the seal. However, a thinner line of sealant creates more challenge due to the fact that the cured sealant needs to have very high adhesion strength and reliability to ensure the quality of the LCD panel, not only in the light covered area but also in the light-shielded area.

There have been several attempts to solve the curability problem in the light-shielded area for an epoxy-acrylate hybrid curable composition. For example, US20070096056 proposes the use of a thiol compound as a chain transfer agent to improve the shadow curability of an epoxy-acrylate hybrid curable composition. However, the combination of thiol compound with the epoxy curing agent such as imidazole or amine will accelerate the reaction of epoxy with thiol, and therefore result in viscosity stability issues at room temperature.

CN101617267 discloses the use of both a thermal radical polymerization initiator and a thiol chain transferring agent in an epoxy-acrylate hybrid curable composition, which can give an increased curability in light-shielded areas and result in good sealing quality. However, with the decrease of line width of the sealant, the adhesion strength and reliability of the cured sealant cannot necessarily ensure the reliability of the liquid crystal display panel.

On the other hand, since 1960s, bismaleimide resins are known for their high performance, such as low moisture absorption, highly crosslinked structures, high chemical resistance and high mechanical stability. These advantages make bismaleimide widely applied in adhesive applications.

It is known that the adhesives containing maleimide compound can be cured without photoinitiator. JP2002338946 discloses sealant composition with a (meth)acrylate oligomer and maleimide derivatives, while JP200334708 discloses a resin composition comprising a maleimide modified epoxy compound. Both of these patent applications intend to address the adhesion and moisture resistance of a liquid crystal sealant or organic element sealant, not the application in the ODF LCD assembly process. JP20052015 proposes a sealant composition with a specific maleimide compound derived from bisphenol S structure, which is claimed to have low liquid crystal contamination and high adhesion strength.

Furthermore, CN101676315 proposes that the sealant containing maleimide compound have the advantage of eliminating photoinitiator. Comparing with a normal epoxy-acrylate hybrid composition with photoinitiator, this photoinitiator-free system can reduce the negative effect of residual photoinitiator on the liquid crystal so that it can ensure the display quality. However, it is noticed that this photoinitiator-free system may not be fully cured in the light-shielded area, thus cause some potential issues such as liquid crystal contamination or reliability issues.

The present invention provides the combination of a thermal free radical initiator and the maleimide resin in order to solve light-shielded area curing issues. As a result, the curable resin composition according to the present invention comprises a maleimide resin, a thermal free radical initiator, an epoxy resin, and a latent epoxy curing agent, which is curable with a combination of UV and heat, thus result in a cured product with good curability in light-shielded area, excellent adhesion strength and high reliability, which is particularly suitable for ODF LCD assembly process.

### BRIEF DESCRIPTION OF THE DRAWINGS

FIG. 1 illustrates how the sample is placed on the indium tin oxide glass for adhesive strength and reliability test.

### SUMMARY OF THE INVENTION

The present invention provides a curable resin composition comprising

a) a maleimide resin selected from the group consisting of

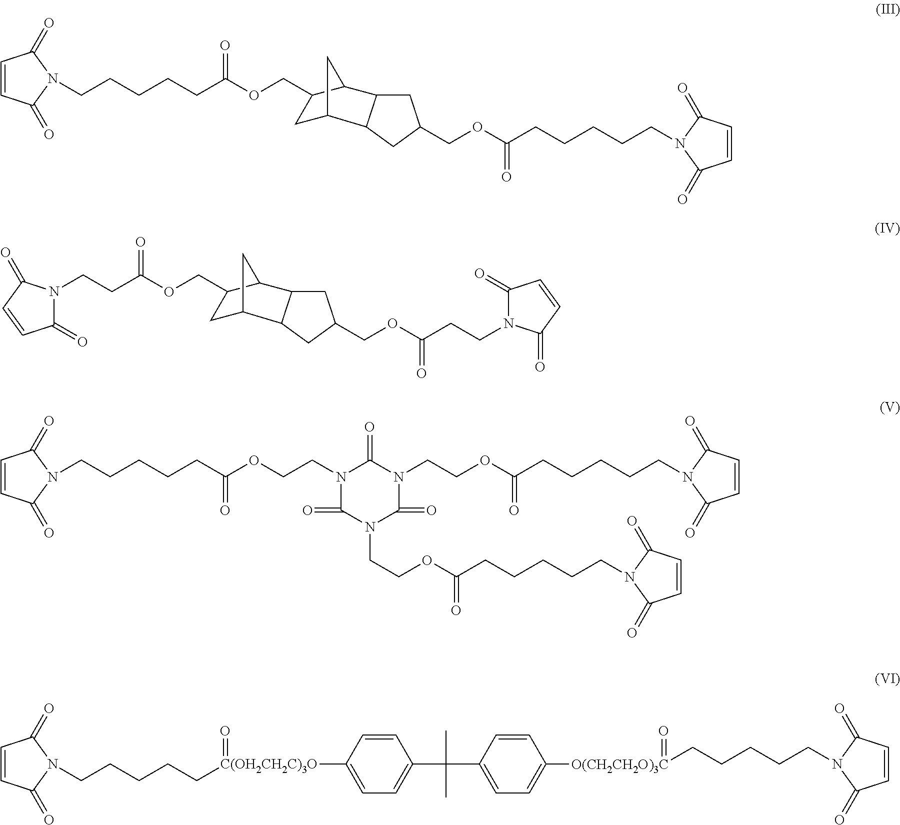

and mixtures thereof;

b) a thermal free radical initiator selected from group consisting of organic peroxides and organic azo compounds; c) an epoxy resin; and d) a latent epoxy curing agent.

The present invention also provides a use of curable resin composition according to the present invention as a sealing agent for a liquid crystal.

Furthermore, the present invention encompasses a method of producing a liquid crystal display having a liquid crystal between a first substrate and a second substrate comprising steps of: 1) applying a curable resin composition according to the present invention on a sealing region at a periphery of a surface of the first substrate; 2) dropping liquid crystal on a central area encircled by said sealing region of the surface of the first substrate; 3) overlaying the second substrate on the first substrate; 4) UV curing; and 5) heat curing.

### DETAILED DESCRIPTION OF THE INVENTION

In the following passages the present invention is described in more detail. Each aspect so described may be combined with any other aspect or aspects unless clearly indicated to the contrary. In particular, any feature indicated as being preferred or advantageous may be combined with any other feature or features indicated as being preferred or advantageous.

In the context of the present invention, the terms used are to be construed in accordance with the following definitions, unless a context dictates otherwise.

As used herein, the singular forms “a”, “an” and “the” include both singular and plural referents unless the context clearly dictates otherwise.

The terms “comprising”, “comprises” and “comprised of” as used herein are synonymous with “including”, “includes” or “containing”, “contains”, and are inclusive or open-ended and do not exclude additional, non-recited members, elements or method steps.

The recitation of numerical end points includes all numbers and fractions subsumed within the respective ranges, as well as the recited end points.

All references cited in the present specification are hereby incorporated by reference in their entirety.

Unless otherwise defined, all terms used in the disclosing the invention, including technical and scientific terms, have the meaning as commonly understood by one of the ordinary skill in the art to which this invention belongs to. By means of further guidance, term definitions are included to better appreciate the teaching of the present invention.

The curable resin composition for sealing liquid crystal according to the invention comprises a maleimide resin, a thermal free radical initiator, an epoxy resin, a latent epoxy curing agent, and optionally other ingredients.

The curable resin composition according to the present invention can be cured into a product with good curability in light-shielded area, excellent adhesion strength and high reliability, which particularly address the light-shielded area curability and reliability requirement for the one-drop-filling liquid crystal display assembly process.

A Maleimide Resin

The curable resin composition for sealing liquid crystal according to the invention comprises a specific maleimide resin.

To provide good processability, the maleimide resin is preferably liquid at room temperature (25° C.). However, the maleimide resin can also be solid on condition that it can be mixed with other components in the resin composition into a liquid state.

Generic maleimide resin has the structure

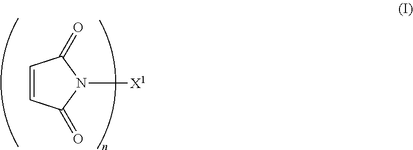

in which n is 1 to 3 and X^{I} is an aliphatic or aromatic group. Exemplary X^{I} entities include, poly(butadienes), poly(carbonates), poly(urethanes), poly(ethers), poly(esters), simple hydrocarbons, and simple hydrocarbons containing functionalities such as carbonyl, carboxyl, amide, carbamate, urea, ester, or ether.

However, the maleimide resin with simple hydrocarbon chain(s) may have compatibility issue with some epoxy resins in the curable resin composition according to the present invention, and therefore, preferred maleimide resins that have better compatibility include generic structure

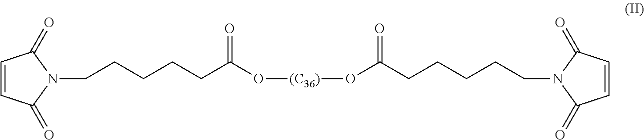

in which C36 represents a linear or branched hydrocarbon chain (with or without cyclic moieties) of 36 carbon atoms.

Suitable maleimide resins to be used in the present invention are selected from the group consisting of following structure:

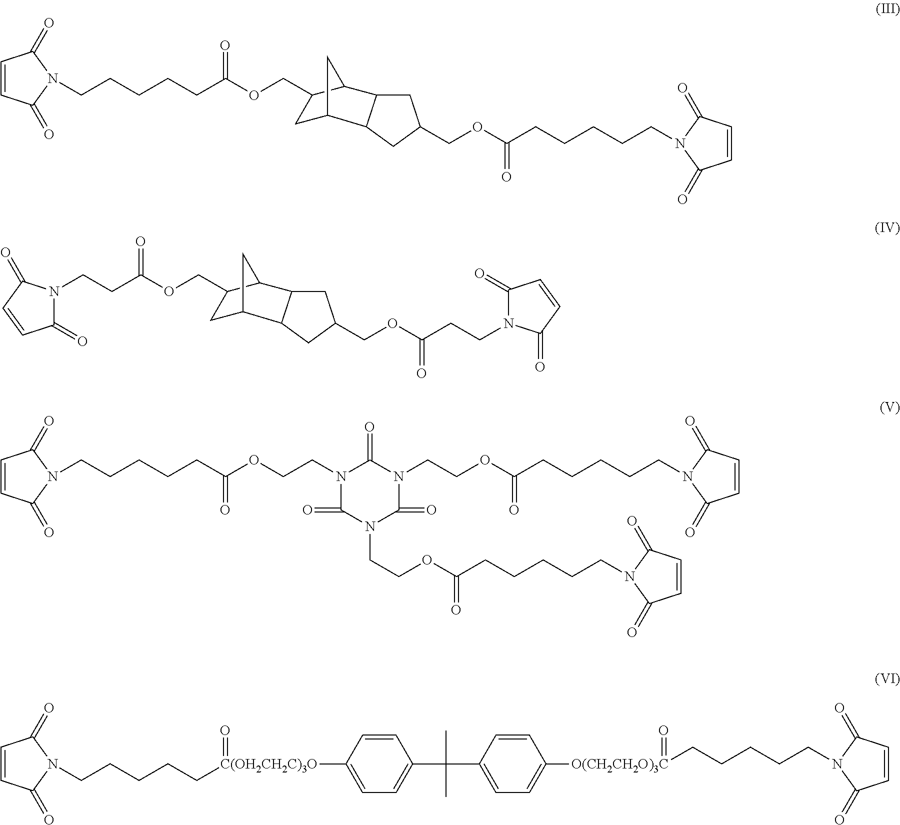

and mixtures thereof.

A curable resin composition according to the present invention comprises maleimide resins selected from the group consisting of formulas III, IV, V, VI and mixtures thereof.

Maleimide resins III-VI are more polar, and therefore, more compatible with the other ingredients, especially, with the epoxy resins used in the present invention. Furthermore, increased polarity improves the adhesion to the substrate.

Preferably a curable resin composition according to the present invention comprises maleimide resin III.

According to the present invention, the selected maleimide resins provide the function of UV curable part upon UV-irradiation, as well as providing the good adhesion and high reliability under high temperature and humidity.

A curable resin composition according to the present invention comprises a maleimide resin preferably from 10% to 90% by weight of the total composition, preferably from 20% to 80%, and most preferably from 30% to 60%.

Ideal maleimide resin quantity in the curable resin composition according to the present invention provides adequate fix during UV cure, without increasing the costs of the composition too high.

A Thermal Free Radical Initiator

The curable resin composition for sealing liquid crystal according to the present invention comprises a thermal free radical initiator.

Thermal free radical initiators are compounds that can decompose and release free radicals when heat activated, thereby initiate the crosslinking reaction of maleimide resin in the light-shielded area.

The curable resin composition for sealing liquid crystal according to the present invention comprises a thermal free radical initiator selected from the group consisting of organic peroxides and organic azo compounds.

Suitable thermal free radical initiators include, for example, organic peroxides and azo compounds that are known in the art. Examples include: azo free radical initiators such as AIBN (azodiisobutyronitrile), 2,2′-Azobis(4-methoxy-2,4-dimethyl valeronitrile), 2,2′-Azobis(2,4-dimethyl valeronitrile), Dimethyl 2,2′-azobis(2-ethylpropionate), 2,2′-Azobis(2-methylbutyronitrile), 1,11-Azobis(cyclohexane-1-carbonitrile), 2,2′-Azobis[N-(2-propenyl)-2-methylpropionamide]; dialkyl peroxide free radical initiators such as 1,1-di-(butylperoxy-3,3,5-trimethyl cyclohexane); alkyl perester free radical initiators such as TBPEH (t-butyl per-2-ethylhexanoate); diacyl peroxide free radical initiators such as benzoyl peroxide; peroxy dicarbonate radical initiators such as ethyl hexyl percarbonate; ketone peroxide initiators such as methyl ethyl ketone peroxide, bis(t-butyl peroxide) diisopropylbenzene, t-butylperbenzoate, t-butyl peroxy neodecanoate, and combinations thereof.

Further examples of organic peroxide free radical initiators include: Dilauroyl peroxide, 2,2-Di(4,4-di(tert-butylperoxy)cyclohexyl)propane, Di(tert-butylperoxyisopropyl) benzene, Di(4-tert-butylcyclohexyl) peroxydicarbonate, Dicetyl peroxydicarbonate, Dimyristyl peroxydicarbonate, 2,3-Dimethyl-2,3-diphenylbutane, Dicumyl peroxide, Dibenzoyl peroxide, Diisopropyl peroxydicarbonate, tert-Butyl monoperoxymaleate, 2,5-Dimethyl-2,5-di(tert-butylperoxy)hexane, tert-Butylperoxy 2-ethylhexyl carbonate, tert-Amyl peroxy-2-ethylhexanoate, tert-Amyl peroxypivalate, tert-Amylperoxy 2-ethylhexyl carbonate, 2,5-Dimethyl-2,5-di(2-ethylhexanoylperoxy) hexane 2,5-Dimethyl-2,5-di(tert-butylperoxy) hexpe-3, Di(3-methoxybutyl)peroxydicarbonate, Diisobutyryl peroxide, tert-Butyl peroxy-2-ethylhexanoate (Trigonox 21 S), 1,1-Di(tert-butylperoxy)cyclohexane, tert-Butyl peroxyneodecanoate, tert-Butyl peroxypivalate, tert-Butyl peroxyneoheptanoate, tert-Butyl peroxydiethylacetate, 1,1-Di(tert-butylperoxy)-3,3,5-trimethylcyclohexane, 3,6,9-Triethyl-3,6,9-trimethyl-1,4,7-triperoxonane, Di(3,5,5-trimethylhexanoyl) peroxide, tert-Butyl peroxy-3,5,5-trimethyl hexanoate, 1,1,3,3-Tetramethylbutyl peroxy-2-ethylhexanoate, 1,1,3,3-etramethylbutyl peroxyneodecanoate, tert-Butyl peroxy-3,5,5-trimethyl hexanoate, Cumyl peroxyneodecanoate, Di-tert-butyl peroxide, tert-Butylperoxy isopropyl carbonate, tert-Butyl peroxybenzoate, Di(2-ethylhexyl) peroxydicarbonate, tert-Butyl peroxyacetate, Isopropylcumyl hydroperoxide, and tert-Butyl cumyl peroxide.

Suitable commercially available thermal free radical initiator to be used in the present invention is for example Perkadox 16, Di(4-tert-butylcyclohexyl) peroxydicarbonate, manufactured by AkzoNobel Polymer Chemicals.

The thermal free radical initiator with higher decomposition rate is preferred, as this can generate free radicals more easily at common cure temperature (80-130° C.) and give faster cure speed, which can reduce the contact time between liquid resin and liquid crystal, and therefore, reduce the liquid crystal contamination. On the other hand, if the decomposition rate of the initiator is too high, the viscosity stability at room temperature will be influenced, and thereby, the work life of the sealant is reduced.

A convenient way of expressing the decomposition rate of an initiator at a specified temperature is in terms of its half-life i.e., the time required to decompose one-half of the peroxide originally present. To compare reactivity of different initiators, the temperature at which each initiator has a half-life (T½) of 10 hours is used. 10 h T½ temperature is defined as the temperature where the thermal free radical initiator decomposes to one-half of the thermal free radical initiator originally present after 10 hours. The most reactive (fastest) initiator would be the one with the lowest 10 h T½ temperature.

In the present invention, the thermal free radical initiator with 10 h T½ temperature of 30-80° C. is preferred, and with 10 h T½ temperature of 40-70° C. is more preferred.

To balance the reactivity and viscosity stability of the composition, the level of the thermal free radical initiator in the curable resin composition is preferably from 0.01% to 5% by weight of the maleimide resin in the total composition and preferably from 0.1% to 3%, most preferably from 0.5% to 2%.

If the composition comprises too high quantity of a thermal free radical initiator, this will have a negative effect on the liquid crystal.

An Epoxy Resin

To further enhance the sealing performance including adhesion strength and reliability, an epoxy resin is used in the curable resin composition. The epoxy resin component of the present invention may include any common epoxy resin, including but not limited to, aromatic glycidyl ethers, aliphatic glycidyl ethers, aliphatic glycidyl esters, cycloaliphatic glycidyl ethers, cycloaliphatic glycidyl esters, cycloaliphatic epoxy resins and mixtures thereof.

At least one solid epoxy resin having a melting point of 40° C. or above is preferred. The incorporation of a solid epoxy resin is important to adjust the viscosity of the curable resin composition according to the present invention to the required level of 150 to 450 Pa·s (measured at 25° C., 15 s-1, detailed method is described in the examples section below) for a one-drop-filling LCD sealant, with improved performance of the sealant, such as higher glass transition temperature, or higher flexibility, or higher adhesion strength, depending on the selected solid epoxy resin. If the viscosity of a one-drop-filling LCD sealant is lower than 150 Pa·s, wet strength of the sealant is not enough when it contacts with liquid crystal under vacuum condition, which causes deformation of the line shape or liquid crystal penetration. On the other hand, if the viscosity is higher than 450 Pa·s, the dispensability of sealant is affected and the dispensing speed influenced.

Moreover, the solid epoxy resin preferably ranges in number average molecular weight of 500 to 3000 g/mol. When the number-average molecular weight is within this range, the solid epoxy resin shows low solubility and diffusibility in the liquid crystal; permits the obtained liquid crystal display panel to exhibit excellent display characteristics; and has good compatibility with the maleimide resin. The number average molecular weight of the epoxy resin can be measured by gel permeation chromatography (GPC) using polystyrene standard.

Specific examples of the solid epoxy resin having a melting point of 40° C. or above include aromatic polyvalent glycidylether compounds obtained by reaction, with epichlorohydrin, of aromatic diols such as bisphenol A, bisphenol S and bisphenol F, or modified diols obtained by modifying the above diols with ethylene glycol, propylene glycol and alkylene glycol; novolak-type polyvalent glycidylether compounds obtained by reaction, with epichlorohydrin, of novolak resins derived from phenols or cresols and formaldehydes, or polyphenols such as polyalkenylphenols and copolymers thereof; and glycidylether compounds of xylylene phenolic resins.

More preferably, cresol novolak epoxy resin, phenol novolak epoxy resin, bisphenol A epoxy resin, bisphenol F epoxy resin, triphenolmethane epoxy resin, tripheolethane epoxy resin, trisphenol epoxy resin, dicyclopentadiene epoxy resin and biphenyl epoxy resin may be used in the present invention, provided that the melting point is 40° C. or above.

Suitable commercially available solid epoxy resin to be used in the present invention are for example Epikote1007, produced from bisphenol A and epichlorohydrin having a melting point between 103-115° C. and molecular weight 2870 g/mol, manufactured by Momentive Specialty Chemicals Inc. and DER661, produced from bisphenol A and epichlorohydrin having a melting point between 75-85° C. and molecular weight 1050 g/mol, manufactured by Dow Chemical.

Regarding the process, it is preferred that the solid epoxy resin is dissolved first in a liquid epoxy resin to obtain epoxy resin mixture and then mix with other components in the curable composition. This is preferred because sometimes it is not easy to dissolve the solid epoxy resin directly into a maleimide resin.

A curable resin composition according to the present invention comprises solid epoxy resin preferably from 1% to 40% by weight of the total composition, preferably from 2% to 30%, and most preferably from 5% to 20%.

Ideal solid epoxy resin level provides viscosity control for the curable resin composition according to the present invention. If the curable resin composition has too high level of solid epoxy resin, the viscosity is too high for composition to be used successfully in sealing the liquid crystal.

If more than one epoxy resins are used, the curable resin composition according to the present invention comprises epoxy resins preferably from 10% to 80% by weight of the total composition, preferably from 20% to 80%, and most preferably from 30% to 60%. Ideal epoxy resins level provides the enhancement of adhesion strength and reliability for the curable resin composition according to the present invention.

A Latent Epoxy Curing Agent

The latent epoxy curing agent is used to cure epoxy resin part when heat is applied. Suitable latent epoxy curing agent can be obtained from the commercially available latent epoxy curing agents and used alone or in a combination of two or more latent epoxy curing agents.

Preferred latent epoxy curing agents to be used in the present invention include amine-based compounds, fine-powder-type modified amine and modified imidazole based compounds. Examples of the amine-based latent curing agent include dicyandiamide, hydrazides such as adipic acid dihydrazide, oxalic acid dihydrazide, malonic acid dihydrazide, succinic acid dihydrazide, glutaric acid dihydrazide, suberic acid dihydrazide, azelaic acid dihydrazide, sebacic acid dihydrazide, and phthalic acid dihydrazide. The modified amine and modified imidazole based compounds include core-shell type in which the surface of an amine compound (or amine adducts) core is coated with the shell of a modified amine product (surface adduction and the like) and master-batch type hardeners as a blend of the core-shell type curing agent with an epoxy resin. These types of latent epoxy curing agents are capable of providing a blend having good viscosity stability and can be cured at a relatively lower temperature (80-130° C.).

Examples of commercially available latent epoxy curing agents include, but not limited to: Adeka Hardener EH-4357S (modified-amine-type), Adeka Hardener EH-4357PK (modified-amine-type), Adeka Hardener EH-4380S (special hybrid-type), Fujicure FXR-1081 (modified-amine-type), Fujicure FXR-1020 (modified-amine-type), Sunmide LH-210 (modified-imidazole-type), Sunmide LH-2102 (modified-imidazole-type), Sunmide LH-2100 (modified-imidazole-type), Ajicure PN-23 (modified-imidazole-type), Ajicure PN-F (modified-imidazole-type), Ajicure PN-23J (modified-imidazole-type), Ajicure PN-31 (modified-imidazole-type), Ajicure PN-31 J (modified-imidazole-type), Novacure HX-3722 (master-batch type), Novacure HX-3742 (master-batch type), Novacure HX-3613 (master-batch type), and the like.

Suitable commercially available latent epoxy curing agents to be used in the present invention are for example EH-4357S (modified-amine-type), manufactured by ADEKA corporation and HX3932HP (microcapsule-type imidazole), manufactured by Asahi Kasei Chemicals Corporation.

Latent epoxy curing agents having a melting point from 50° C. to 110° C., particularly having a melting point of 60° C. to 80° C. are preferred. Those having a melting point lower than 40° C. have the problem of poor viscosity stability, while those having a melting point higher than 120° C. need longer time of thermal cure, which causes a higher tendency of liquid crystal contamination.

The amount of the latent epoxy curing agent used in the curable resin composition may be appropriately selected depending on the kind of the latent curing agent and the epoxy amount in the epoxy resin contained in the curable resin composition.

A curable resin composition according to the present invention comprises latent epoxy curing agent preferably from 1% to 40% by weight of the total composition, preferably from 3% to 30%, and most preferably from 5% to 20%.

Optional Ingredients

The curable resin composition may optionally contain, as necessary, further a component capable of a photopolymerization reaction such as a vinyl ether compound or a (meth)acrylate compound. In addition, the curable resin composition may further comprise additives, resin components and the like to improve or modify properties such as flowability, dispensing or printing property, storage property, curing property and physical property after curing.

The component that may be contained in the composition as needed includes, for example, organic or inorganic filler, thixotropic agent, silane coupling agent, diluent, modifier, coloring agent such as pigment and dye, surfactant, preservative-stabilizer, plasticizer, lubricant, defoamer, leveling agent and the like; however it is not limited to these. In particular, the composition preferably comprises an additive selected from the group consisting of organic or inorganic filler, a thixotropic agent, and a silane coupling agent.

The filler includes, but not limited to, inorganic filler such as silica, diatomaceous earth, alumina, zinc oxide, iron oxide, magnesium oxide, tin oxide, titanium oxide, magnesium hydroxide, aluminium hydroxide, magnesium carbonate, barium sulphate, gypsum, calcium silicate, talc, glass bead, sericite activated white earth, bentonite, aluminum nitride, silicon nitride, and the like; meanwhile, organic filler such as poly methyl methacrylate, poly ethyl methacrylate, poly propyl methacrylate, poly butyl methacrylate, butylacrylate-methacrylic acid-methyl methacrylate copolymer, poly acrylonitrile, polystyrene, poly butadiene, poly pentadiene, poly isoprene, poly isopropylene, and the like. These may be used alone or in combination thereof.

The thixotropic agent includes, but not limited to, talc, fume silica, superfine surface-treated calcium carbonate, fine particle alumina, plate-like alumina; layered compound such as montmorillonite, spicular compound such as aluminium borate whisker, and the like. Among them, talc, fume silica and fine alumina are preferred.

The silane coupling agent includes, but not limited to, γ-aminopropyltriethoxysilane, γ-mercaptopropyltrimethoxysilane, γ-methacryloxypropyltrimethoxysilane, γ-glycidoxyp-ropyltrimethoxylsilane, and the like.

The curable resin composition according to the present invention may be obtained by mixing the aforementioned each component by means of, for example, a mixer such as a stirrer having stirring blades and a three roll mill. The composition is liquid at ambient with the viscosity of 150 to 450 Pa·s (at 25° C.) at 1.5 s-1 shear rate (the test method is described more in detail in the examples section below), which allows its easy dispensing property.

Even without any photoinitiator, the maleimide resin component in the curable resin composition allows its curability upon UV-irradiation, with irradiation energy of 1,000-5,000 mJ/cm², preferably with irradiation energy of 2,000-3,000 mJ/cm². Meanwhile, the thermal free radical initiator, epoxy resin, and latent curing agent components in the curable resin composition provide the curability upon heating, within a range of temperature of 80 to 130° C., preferably of 100 to 120° C., with the heating time of 30 mins to 3 hours, typically 1 hour.

In that case, the curable resin composition according to the present invention can be temporally cured through UV-irradiation to allow fixing position, and then finally cured by heating including the light-shielded area. Therefore, the curable resin composition according to the present invention is suitable for sealing liquid crystal by means of liquid crystal one-drop-filling process.

Furthermore, the present invention also relates to a method for manufacturing a liquid crystal display having a liquid crystal layer between a first substrate and a second substrate, by means of a liquid crystal one-drop-filling process.

The method according to the present invention comprises the steps of

(a) applying the curable resin composition described in the present invention on a sealing region at periphery of a surface of the first substrate;

(b) dropping liquid crystal on a central area encircled by the sealing region of the surface of the first substrate;

(c) overlaying the second substrate on the first substrate;

(d) performing temporal fixation by UV-irradiating the curable composition, and

(e) performing final fixation by heating the curable composition.

The first substrate and the second substrate used in the present invention are usually transparent glass substrates. Generally, transparent electrodes, active matrix elements (such as thin film transistor TFT), alignment film(s), a color filter and the like are formed on at least one of the opposed faces of the two substrates. These constitutions may be modified according to the type of the LCD. The manufacturing method according to the present invention may be thought to be applied for any type of the LCD.

In the step (a), the curable resin composition is applied on the periphery portion of the surface of the first substrate so as to lap around the substrate circumference in a frame shape. The portion where the curable resin composition is applied in a frame shape is referred as a seal region. The curable resin composition can be applied by a known method such as screen printing and dispensing.

In the step (b), the liquid crystal is then dropped onto the center region surrounded by the seal region in the frame shape on the surface of the first substrate. This step is preferably conducted under reduced pressure.

In the step (c), said second substrate is then placed over said first substrate, and UV-irradiated in the step (d). By the UV-irradiation, the curable resin composition cures temporally and shows the strength at a level that displacement does not occur by handling, whereby the two substrates are temporally fixed. Generally, the radiation time is preferably short, for example no longer than 5 minutes, preferably no longer than 3 minutes, more preferably no longer than 1 minute.

In the step (e), heating the curable resin composition allows it to achieve the final curing strength, whereby the two substrates are finally fixed. The thermal curing in the step (e) is generally heated at a temperature of 80 to 130° C., preferably at temperature of 100 to 120° C., with the heating time of 30 minutes to 3 hours, typically 1 hour.

By the aforementioned process, the major part of the LCD panel is completed.

The curable resin composition to be used in the present invention may be also used for other applications than the liquid crystal one-drop-filling process, where precise assembling without displacement is necessary. For example, the image sensor bonding application.

The curable resin composition according to the present invention provides a good curability in light-shielded area and excellent adhesion strength and reliability.

### Examples

TABLE 1
(the units of values are represented by wt %)

| | | Example | | | Comparative example | | |
|---|---|---|---|---|---|---|---|
| Items | Composition | 1 | 2 | 3 | 1 | 2 | 3 |
| Maleimide resin | BMI-4*¹ | 47 | 36 | 36 | | 47 | |
| | X-BMI*² | | | | | | 41 |
| Thermal free | Perkadox 16*³ | 0.3 | 0.2 | 0.5 | | | 0.3 |
| radical initiator | | | | | | | |
| Liquid epoxy | EPICLON 850S*⁴ | 23 | 26 | 30 | 29 | 23 | 23 |
| resin | | | | | | | |
| Solid epoxy | Epikote1007*⁵ | 8 | | | 6 | 8 | 12 |
| resin | DER661*⁶ | | 16 | 7.3 | | | |
| Latent epoxy | EH-4357S*⁷ | | | 18.4 | | | |
| curing agent | HX3932HP*⁸ | 13 | 14 | | 15 | 13 | 12 |
| Acrylate resin | Ebecryl 3700*⁹ | | | | 41 | | |
| Photoinitiator | Irgacure 651*¹⁰ | | | | 0.4 | 0.3 | |
| Inorganic filler | SO-E2*¹¹ | | 5.6 | | | | |
| Organic filler | F-351*¹² | 7 | | 6.1 | 7.9 | 7 | 9.3 |
| Thixotropic | Aerosil R805*¹³ | 1 | 1.5 | 1 | | 1 | 1.7 |
| agent | | | | | | | |
| Silane coupling | γ-glycidoxypropyl | 0.7 | 0.7 | 0.7 | 0.7 | 0.7 | 0.7 |
| agent | trimethoxylsilane | | | | | | |

BMI-4, manufactured by Henkel Corporation

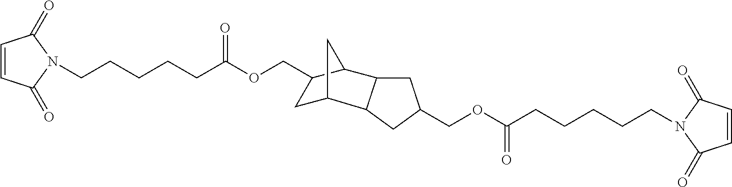 [SMILES: O=C(CCCCCN1C(=O)C=CC1=O)OCC1CC2C3CC(COC(=O)CCCCCN4C(=O)C=CC4=O)C(C3)C2C1]

X-BMI, manufactured by Henkel Corporation

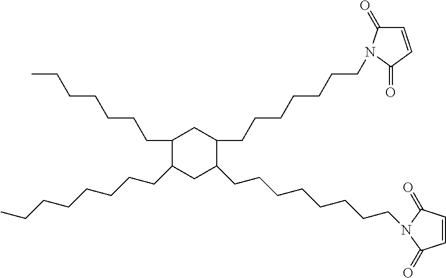 [SMILES: CCCCCCCCC1CC(CCCCCCCCN2C(=O)C=CC2=O)C(CCCCCCCN2C(=O)C=CC2=O)CC1CCCCCCC]

Perkadox 16, Di(4-tert-butylcyclohexyl) peroxydicarbonate, 10 hr.−T½=40.8° C., manufactured by AkzoNobel Polymer Chemicals.

EPICLON 850S, Bisphenol A type epoxy, manufactured by Dainippon Ink & Chemicals, Inc.

Epikote1007, produced from bisphenol A and epichlorohydrin, mp=103-115° C., Molecular weight 2870, manufactured by Momentive Specialty Chemicals Inc.

DER661, produced from bisphenol A and epichlorohydrin, mp=75-85° C.; Molecular weight 1050, manufactured by Dow Chemical.

EH-4357S, modified amine, manufactured by ADEKA corporation, further grounded to fine powder.

HX3932HP, microcapsule-type imidazole, manufactured by Asahi Kasei Chemicals Corporation.

Ebecryl 3700, acrylate ester of bisphenol-A based epoxy, manufactured by Cytec Industries Inc.

Irgacure 651, manufactured by BASF.

SO-E2, silica, average particle size 0.5 μm, manufactured by Admatechs Co. Ltd.

ZEFIAC F351, Butylacrylate-methacrylic acid-methylmethacrylate copolymer, average particle size 0.3 μm, manufactured by Ganz Chemical Co., Ltd.

Aerosil R805, manufactured by Evonik Industries.

The materials listed in the Table 1 were sufficiently mixed by a stirrer and then a three roll miller to give the curable resin compositions: The samples are tested by using below described testing methods.

Test Methods

Viscosity and Viscosity Stability

The initial viscosity of the resin composition at 25° C. was measured by rheometer (TA, AR2000 ex) at a shear rate of 15 s-1. An opaque polyethylene jar was charged with 10 grams of the resin composition and tightly sealed, then after storage at 25° C. for 7 days, the viscosity value at a shear rate of 15 s-1 was measured again. The initial viscosity and viscosity increase after 7 days (versus initial viscosity) are shown in table 2. The viscosity increase ratio of less than 25% represents good storage stability, while of more than 25% represents poor storage stability.

Adhesive Strength and Adhesion Reliability after Storage Under High Temperature and High Humidity

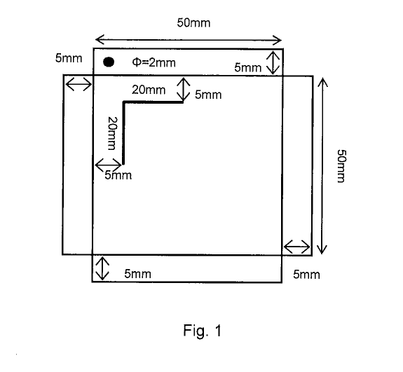

1 wt % of total composition of 5 μm spacer was added to the resin composition, which was then dispensed (using Asymtek) on an ITO (Indium Tin Oxide) glass of 50 mm×50 mm×0.7 mm to form two crossed line having a length of 20 mm and a diameter of about 0.7 mm respectively (as shown in FIG. 1). A similar counter ITO glass was crosswise superposed to join them, fixed under loading and photo-curing was performed using a ultraviolet (UV) radiator (Fusion UV, with D lamp) with exposure energy of 3000 mJ/cm², then the specimen was subject to heat-treatment in an oven at 120° C. for 60 minutes. The resultant specimen was tested by fixing the top glass in the mould, and pressing on the bottom glass by a metal column (with a diameter of 2 mm, as shown in FIG. 1) at a pressing rate of 1.27 mm/s (using Instron tester). The largest press strength value was recorded and the line width divided by the press strength was referred to as adhesive strength (N/mm).

The Test Specimen for Adhesion Strength

The adhesion specimen was produced in the same manner as in the above-described, and stored in a high temperature and high humidity chamber at a temperature of 60° C. and a humidity of 90% for 5 days (120 hrs), then the adhesion strength was tested using the same test method as described above. The maintenance of the adhesive strength relative to the adhesive strength before the high temperature and high humidity storage of more than 50% represents good adhesion reliability after high-temperature and high humidity storage; the maintenance of less than 50% represents poor adhesion reliability after high temperature and high humidity storage.

Reaction Ratio of C≡C

1 gram of the resin composition was applied to a 1 mm thick glass plate to form a dome shape with a diameter of about 4 mm to make a specimen. The specimen was irradiated with 3000 mJ/cm² of UV light (by Fusion UV, with D lamp) followed by heat-treatment in an oven at 120° C. for 60 minutes (recorded as UV and heat sample). As a comparison, the specimen with the same resin composition was only cured by heat at 120° C. for 60 minutes (recorded as heat sample). The specimen was analyzed by FT-IR spectrometry before and after the curing process. The reaction ratio of C≡C in maleimide resin or acrylate resin (only in comparative example 1) was calculated from the peak area assigned to the maleimide (690 cm⁻¹) or acryl group (1405 cm⁻¹) and reference peak area (2950 cm⁻¹).

Liquid Crystal Sealing Performance Evaluation

1 wt % of total composition of 5 μm spacer was added to the resin composition. Then 2 mg obtained composition was dispensed (using Asymtek) in a rectangular shape at periphery of the surface of a glass substrate (20 mm×70 mm). Later 7 mg liquid crystal was dropped on the central area encircled by the sealing region and degassed in vacuum, followed by overlaying a second glass substrate on the first substrate. After the attachment of two glass substrates, the vacuum was released to obtain the specimen. The specimen was then irradiated with 3000 mJ/cm² of UV light (by Fusion UV, with D lamp). After UV radiation, the temporal fixation quality by UV-irradiating was evaluated by manual. The UV fixablity was recorded as “good” if the glass substrates cannot be displaced by manual; it was recorded as “poor” if the glass substrates can be displaced easily by manual.

The specimen after UV radiation was then heat treated in an oven at 120° C. for 60 minutes, in order to complete a mimic LCD cell with the one-drop-filling process. The obtained mimic LCD cell was inspected under a microscope to verify the sealing performance, such as the sealing shape maintenance and liquid crystal leakage. The sealing performance was recorded as “good” if the sealing shape was well kept and no liquid crystal leakage, while it was recorded as “poor” if there was liquid crystal leakage.

The test results are shown in Table 2.

TABLE 2
test results

| | | | | | Comparative | | |
|---|---|---|---|---|---|---|---|
| | | Example | | | example | | |
| Test items | | 1 | 2 | 3 | 1 | 2 | 3 |
| Viscosity | Pa · s at 15 s−1 | 327 | 300 | 350 | 321 | 327 | 240* |
| Viscosity stability | 25° C. for 7 | Good | Good | Good | Good | Good | — |
| | days | | | | | | |
| Reaction ratio of | UV + heat | 100% | 100% | 100% | 99% | 100% | — |
| C═C | Only heat | 100% | 100% | 100% | 27% | 51% | — |
| Adhesive strength | N/mm | 25.6 | 16.9 | 19.7 | 10.2 | 16.4 | 6.9 |
| Adhesion reliability | after 60° C./ | Good | Good | Good | Poor | Good | — |
| | 90% humidity | | | | | | |
| | for 120 hrs | | | | | | |
| Liquid crystal | After UV | Good | Good | Good | Good | Good | — |
| sealing | radiation | | | | | | |
| performance | After UV + heat | Good | Good | Good | Good | Good | — |

*X-BMI was not compatible with epoxy resins in comparative example 3.

As shown from the results of Table 2, all the examples (1-3) showed viscosity in the range of 150-450 Pa·s, as well as good viscosity stability. It was confirmed that although the thermal free radical initiator was used, as long as the initiator type and ratio were properly selected, the viscosity stability could be ensured. However, it was noticed in comparative example 3 that, the X-BMI was not compatible with the liquid epoxy and solid epoxy resin mixture, which is probably due to the long hydrocarbon chain and low polarity in X-BMI.

The reaction ratio of C═C in examples (1-3) all showed that the C═C can be fully cured under UV plus heat condition, or even heat-only condition. This can be deduced that even in the light-shielded area when there is no UV irradiation, the C═C in maleimide resin can further crosslink upon heat, thus reduce the risk of liquid crystal contamination. On the other hand, comparative examples 1 and 2 showed much less reaction ratios of C═C under heat-only condition, which means that there is a high possibility of uncured resin in the light-shielded area on the substrates.

Comparing with comparative example 1, which is a common epoxy acrylate hybrid mixture composition, it can be seen that all the examples 1-3 with maleimide epoxy hybrid composition showed much higher adhesion strength, as well as good adhesion reliability after storing under high temperature and high humidity. It can be deduced that the composition disclosed in present invention has more advantages in the newly designed “slim border” (or narrow bezel) LCD, where high adhesion strength and reliability of sealant with thinner line is required to ensure the quality of the LCD panel.

Comparing with example 1 and comparative example 2, the only difference in the composition is the initiator type. Example 1 that with the thermal initiator had much higher adhesion strength than comparative example 2 (25.6 versus 16.4), this can be supposed that the free radicals generated by thermal initiator can give better crosslink structure in the heat cure process. Therefore, in the present invention, the thermal initiator is provided to ensure the high adhesion strength, as well as the light-shielded area curability. Meanwhile, the comparative example 3 showed very low adhesion strength, which was due to the incompatibility of the X-BMI and epoxy resins. Therefore, the compatibility is very important when choosing the resin combination.

Regarding the liquid crystal sealing performance, as shown in Table 2, all samples (including examples 1-3) exhibited satisfied fixability after UV irradiation and good sealing status after final fixing by heat. This again confirms that the temporal fixing can be achieved by a maleimide-epoxy composition without any photoinitiator as disclosed in the prior art.

What is claimed is:

1. A curable resin composition comprising
a) a maleimide resin selected from the group consisting of 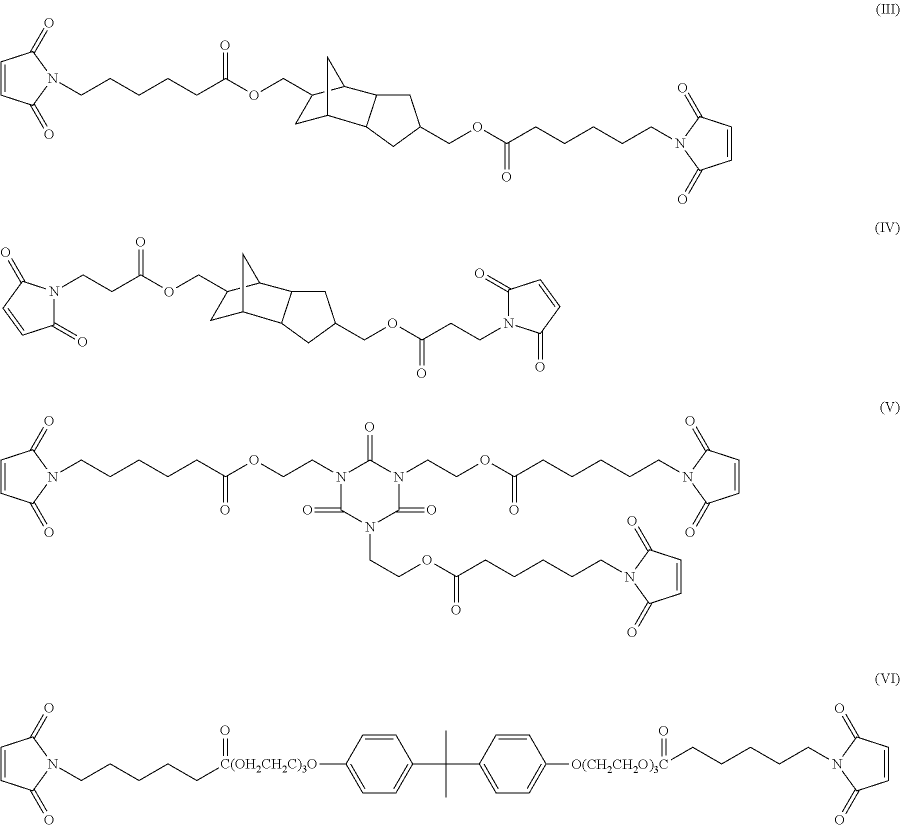
and mixtures thereof;
b) a thermal free radical initiator selected from the group consisting of organic peroxides and organic azo compounds;
c) an epoxy resin; and
d) a latent epoxy curing agent.

2. A curable resin composition according to claim 1, wherein said composition comprises maleimide resin from 10% to 90% by weight the total composition, preferably from 20% to 80% and more preferably from 30% to 60%.

3. A curable resin composition according to claim 1, wherein said thermal free radical initiator has 10 hour half-life (10 h T½) temperature at 30-80° C., more preferably 10 h T½ temperature at 40-70° C., wherein 10 h T½ temperature is defined as the temperature where the thermal free radical initiator decomposes to one-half of the thermal free radical initiator originally present after 10 hours.

4. A curable resin composition according to claim 1, wherein said composition comprises thermal free radical initiator from 0.01% to 5% by weight of the maleimide resin, preferably from 0.1% to 3%, and most preferably from 0.5% to 2%.

5. A curable resin composition according to claim 1, wherein said epoxy resin is solid epoxy resin having number average molecular weight from 500 to 3000 g/mol measured by gel permeation chromatography (GPC) using polystyrene standard.

6. A curable resin composition according to claim 1, wherein said composition comprises epoxy resin from 10% to 80% by weight of the total composition, preferably from 20% to 80%, and most preferably from 30% to 60%.

7. A curable resin composition according to claim 1, wherein said latent epoxy curing agent preferably has a melting point from 50° C. to 110° C., and most preferably from 60° C. to 80° C.

8. A curable resin composition according to claim 1, wherein said composition comprises latent epoxy curing agent from 1% to 40% by weight of the total composition of, preferably from 3% to 30%, and most preferably from 5% to 20%.

9. A curable resin composition according to claim 1 further comprises ingredients selected from the list consisting of additives, resin components ETC, including but not limited to vinyl ether compound or a (meth)acrylate compound, organic or inorganic filler, thixotropic agent, silane coupling agent, diluent, modifier, coloring agent, surfactant, preservative-stabilizer, plasticizer, lubricant, defoamer, leveling agent.

10. A curable resin composition according to claim 1 preferably comprises an organic or inorganic filler, a thixotropic agent, and a silane coupling agent.

11. A curable resin composition according to claim 1, wherein said composition has viscosity from 150 to 450 Pas at 25° C. 15 s⁻¹ measured by rheometer TA, AR2000 ex according to the method described in the application, preferably from 200 to 400 Pas at 25° C. 15 s⁻¹, most preferably from 250 to 350 Pas at 25° C. 15 s⁻¹.

12. Use of curable resin composition according to claim 1 for sealing a liquid crystal.

13. A method of producing a liquid crystal display having a liquid crystal layer between a first substrate and a second substrate comprising steps of:
1) applying a curable resin composition according to claim 1 on a sealing region at a pheriphery of a surface of the first substrate;
2) dropping liquid crystal on a central area encircled by said sealing region of the surface of the first substrate;
3) overlaying the second substrate on the first substrate;
4) UV curing; and
5) Heat curing.

14. A method according to claim 13, wherein the cure is performed at the temperature from 80° C. to 130° C., preferably from 100° C. to 120° C.
